(19) United States
(12) Patent Application Publication
(10) Pub. No.: US 2018/0289024 A1
(43) Pub. Date: Oct. 11, 2018

(54) Fish securing device for cleaning fish

(71) Applicants: David Kuznia, Lake Ariel, PA (US); Rick Cabrera, New York City, NY (US)

(72) Inventors: David Kuznia, Lake Ariel, PA (US); Rick Cabrera, New York City, NY (US)

(21) Appl. No.: 15/483,870

(22) Filed: Apr. 10, 2017

(51) Int. Cl. A22C 25/00

(52) U.S. Cl. CPC A22C 25/006; A22C 25/17

(57) ABSTRACT

An integral hand-held device for manually securing a fish to facilitate its immovability during a fish cleaning process. The fish securing device has a handle which is adapted to be gripped by a user. The handle encases a portion of a cylindrical stem having an inner and outer surface. The portion of the stem not encased by the handle has at its forward end a serrated edge adapted to engage a fish. A user grips the handle with one hand and applies downward pressure with the securing device so that the edge penetrates a fish securing it to a cutting surface while the other hand utilizes an instrument, such as a knife, to clean the fish by filleting, skinning, gutting and/or scaling the fish. Depending on the fish type or thickness it may be necessary for a portion of the stem not encased to also penetrate the fish.

### BACKGROUND

### Field of the Invention

This invention allows a person to secure a fish or small portion of a fish against a cutting surface in order to clean the fish or main portion of the fish as necessary, such as fillet, skin, gut and/or scale the fish, with a cutting instrument such as a knife.

It is an object of this invention to provide a manual device that can firmly secure a fish or a portion of a fish to a cutting surface during a fish cleaning process as a knife is moved through or against the fish or a portion of the fish.

It is another object of this invention to provide a securing device that can be easily and readily used by a user during a fish cleaning process while protecting the user from coming into contact or near contact of the fish and knife.

It is another object of this invention to provide a device that while securing a fish to a cutting surface the device prevents the fish from slipping or tearing.

It is another object of this invention to afford a user flexibility, fluidity, and freedom of movement without slowing or interrupting a fish cleaning process.

It is another object of this invention to provide a securing device for cleaning fish which is simple and practical to use without the need for set up, has no moving parts, and does not require adjustment to the type of fish.

It is another object of this invention to provide a securing device that is quick and effective in its application without the need to attach, wear, or apply to a user's body part.

Another object of this invention is to provide a securing device that can be produced as an integral one-piece device suitable for use in a fishing environment, or where a fish may be cleaned under less than ideal conditions, such as outdoors or near water.

Another object of this invention is to provide a securing device that is durable, convenient, safe, and comfortable to use with a knife in any task necessary for cleaning fish such as filleting, skinning, scaling and/or gutting.

Another object of this invention is to provide a securing device that can be easily stored with other fish cleaning or fishing items.

Another object of this invention is to provide a securing device that can be easily maintained and cleaned for continuous reuse.

Other objects and advantages reside in the invention's type of materials, purpose of materials used, construction of parts, the combination thereof, the method of production and the mode of use, as will become apparent from the following description.

### Description of the Prior Art

A fish can be cleaned by filleting, skinning, gutting and/or scaling, depending on the type of fish. Regardless of which tasks are necessary to manually clean a particular fish, a user always needs to secure a fish against a suitable surface to clean the fish. A fish can be very slippery, abrasive, sharp, and offensive smelling making it difficult to obtain an effective grip, which is necessary to properly clean a fish. Even if a grip is obtained it is usually with discomfort, risk of harm to the finger or hand, or is simply an unpleasant process. Numerous devises have been provided to secure a fish during a manual fish cleaning process. The basic concept with all these prior inventions is to assist a user in the cleaning of a fish so that the user's actual finger, hand, or body part does not come into direct contact with the fish. These devices can be apparatuses with moving or multiple parts, and include blades or attachments. Others are devices that require the device to be applied to a persons' body part, typically finger(s) or hand. Some require a specific set of circumstances to exist in order to use the device in an effective manner. These devices are cumbersome, costly, ineffective, or impractical.

Information relevant to attempts to address these problems can be found in U.S. Pat. Nos. 8,821,223, 6,942,562, 6,602,124, 5,318,472, 4,821,378, 4,797,974, 4,615,078, 4,759,101, 4,149,296. However each of these references suffers from one or more following disadvantages as set forth below.

Hand gloves have been provided with finger portions having corrugations for gripping the fish body or fillet. Gloves become ineffective after a few uses because they become slippery from the fish residue trapped in the corrugations of the gloves. They are also impractical because during the use of such a glove the user's freedom of movement to perform other operations or tasks is limited as a user's hands are committed to the glove until removed. Even the ability to scratch a body part or brush away hair from the eyes is hindered by the use of such a glove. Since the gloves are a disposable device with limited usage and unable to be completely sanitized, repurchase is necessary. Variations of the glove device concept have been provided such as a wearable gripping tool, but this puts a user's hand or finger in contact, or near contact, with the fish during the cleaning process.

Apparatuses have been provided with securing surfaces and blades or attachments such as clamps. Different versions have been provided ranging in complexity, where along with securing a fish to a cutting surface there are also specialty blades for cutting, grooves for liquid run off, and other additional features. Typically, the simplest apparatus consists of a cutting surface and a clamp at one end. All these apparatuses are cumbersome as space is required to set up the apparatus for use or to transport the apparatus. Also, the user is committed to the location of the apparatus when in use, which makes it inconvenient to relocate the cleaning process quickly and easily. Often assembly is required, moving parts break, and the overall costs may increase due to maintenance of the apparatus. Once in use, constant readjustment is necessary to tweak components of the apparatus to secure a new fish (additional readjustment is necessary when the new fish is of a different type or thickness) which slows down the user's fluidity of movement and makes the fish cleaning process more troublesome and take longer than necessary.

Clamps and pincers exist separate from an apparatus combination, but are dependent on factors that also slow down or hinder the fish cleaning process. Clamps and pincers have to be adjusted to the thickness of a securing surface and cannot be used if an appropriate undersurface or space does not exist to properly mount the clamp or pincer. Even when a suitable surface is available, clamps or pincers do not provide the sensitivity of pressure as that of the human touch. Such uncontrolled pressure by the clamp or pincer creates an increased likelihood that either too little or too much pressure is being applied which can cause the fish to break away or tear. Since fish vary in type and thickness, the clamp or pincer may need to be adjusted with each fish, which adds additional steps and delays to the fish cleaning process.

Thumb thimbles and wearable finger retaining devices exist that are designed to adapt to a persons' finger or thumb and provide users with the ability to apply controlled pressure. Although not a hand gripper tool where the whole hand comes into contact with the fish, these devices still cause a user's finger(s) to come into contact with the fish. These devices cause a user's finger(s) wearing the device to come into contact with the fish even if partially or its residue; are dangerously close to the fish and the knife when engaged in cleaning the fish; and those fingers not wearing the device are held at an uncomfortable angle in the air. Even the applied pressure is awkward. A user's finger with a small attachment is incapable of properly securing all types of fish and cannot adequately protect a user's finger or hand in the fish cleaning process due to the proximity of the fish or knife to a body part.

For the foregoing reasons there is a need for a hand held device that can be used by users to secure a fish against a cutting surface during any task(s) necessary to clean a fish, such as filleting, skinning, gutting and/or scaling similar to when a fork is used to assist a knife in the cutting or preparation of meat for human consumption.

### SUMMARY

The present invention is directed towards a hand held device that when used by a user secures a fish against a cutting surface during any task(s) necessary to clean a fish such as filleting, skinning, gutting and/or scaling. This device satisfies these needs. It permits a user to comfortably hold a device in one hand to secure a fish while simultaneously using the other hand to operate a knife to clean the fish. Through the use of the device the user does not have to use, or come near, a body part such as a hand or finger(s) to secure a fish in place, which allows a user to avoid contact or near contact with the fish or knife. This makes the fish cleaning process safer, cleaner, and less unpleasant. Since a user applies human touch to the device it permits a higher degree of control on the pressure applied to secure a fish. This user-controlled pressure decreases the likelihood of a fish slipping or tearing during the cleaning process because a user can instantaneously adjust pressure with the device as necessary. The device is convenient to use as a user can simply put the device down or embed it into a cutting surface (even with the fish still secured to it) thus freeing a hand for any desired purpose. The device can be used for a variety of fish types or thicknesses, easily stored with a knife or other fishing items, and increases the speed and efficiency of the fish cleaning process. The device does not require assembly, mounting, or adjustments of any type. It can be reused, easily cleaned, and is suitable for use in practically any environment including indoors, outdoors, or near water.

A fish securing device for fish cleaning having features of the present invention compromises a stem and a handle, the handle being attached to a portion of the stem as an integral piece. The stem being generally an extended cylinder having an inner and outer surface where the portion of the stem extending from the handle forms a securing edge at its forward end. The securing edge having a plurality of serrated or jagged teeth able to pierce through the flesh or skin of a fish and secure it against a cutting surface. The handle able to be gripped by a user. A user grips the handle and applies downward pressure to embed the securing edge (and depending on the fish type or thickness may also embed some of the forward portion of the stem) through a fish to secure it against a surface for any task associated with cleaning that particular fish, such as filleting, skinning, gutting and/or scaling.

### BRIEF DESCRIPTION OF THE DRAWINGS

FIG. 1 is a perspective view of the fish securing device;

FIG. 2 is a front elevational view of the fish securing device of FIG. 1;

FIG. 3 is a back elevational view of the fish securing device of FIG. 1;

FIG. 4 is a left side elevational view, party in diagram form, of the fish securing device of FIG. 2;

FIG. 5 is a right side elevational view, partly in diagram and partly in phantom, of the fish securing device of FIG. 2;

FIG. 6 is a top plan view, partly in diagram form, of the fish securing device of FIG. 2;

FIG. 7 is a bottom plan view, partly in diagram form, of the fish securing device of FIG. 2;

FIG. 8 is an enlarged side elevational view of the securing edge of the fish securing device of FIG. 2;

FIG. 9 is a side elevational view of a portion of the securing edge of the fish securing device of FIG. 2;

FIG. 10 is a bottom plan view of a segment of teeth in accordance with the fish securing device of FIG. 2

FIG. 11 is a plan view of an inward and outward tooth form in accordance with the fish securing device of FIG. 2

FIG. 12 is a left side elevational view of a user gripping higher up on the handle of the fish securing device of FIG. 2

FIG. 13 is a left side elevational view of a user gripping lower down on the handle of the fish securing device of FIG. 2

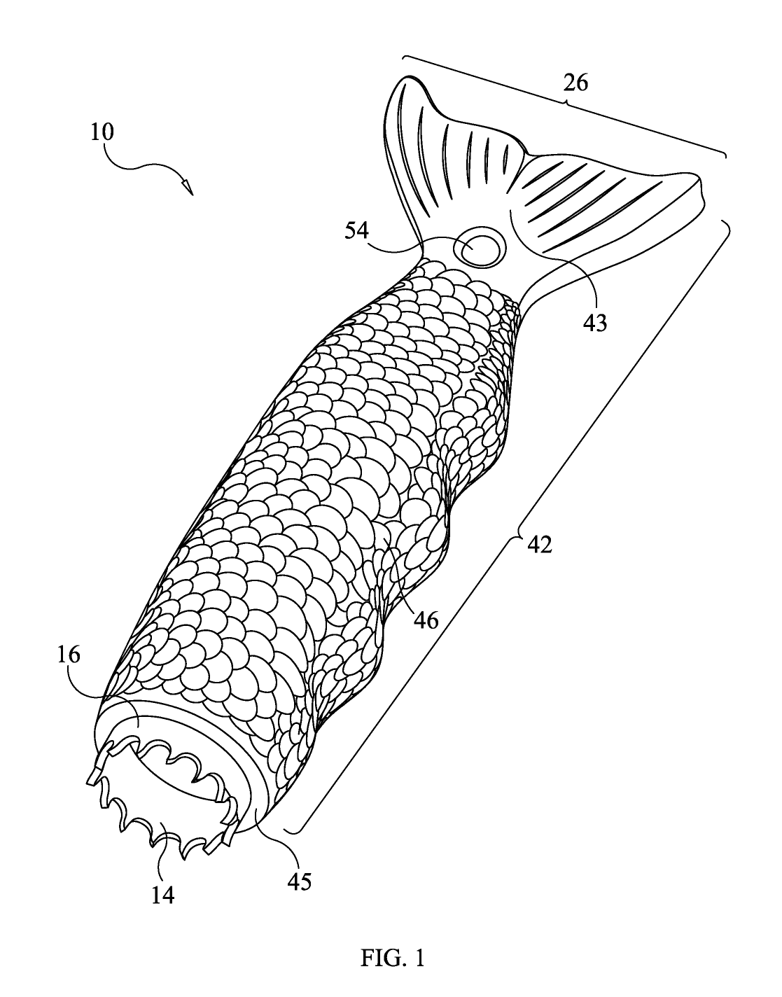

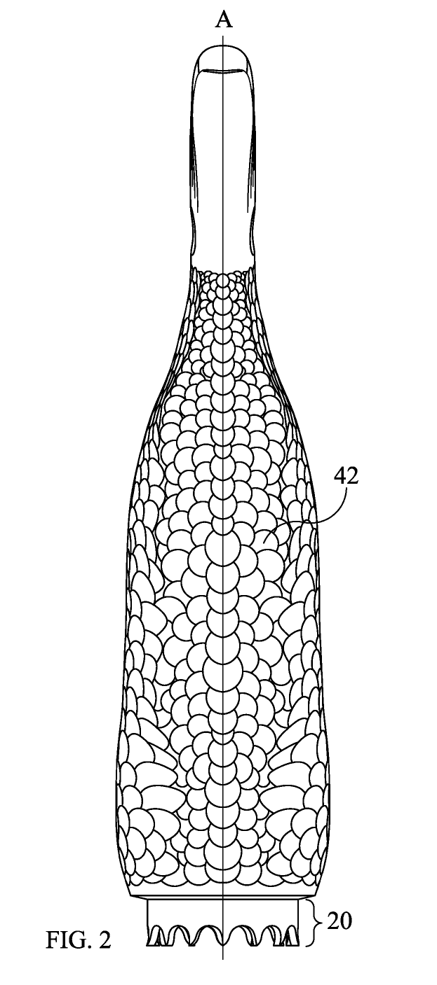

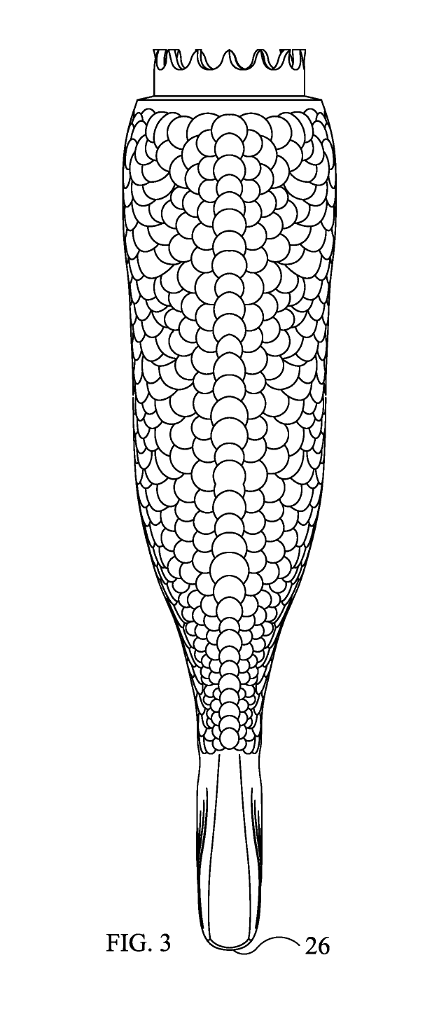

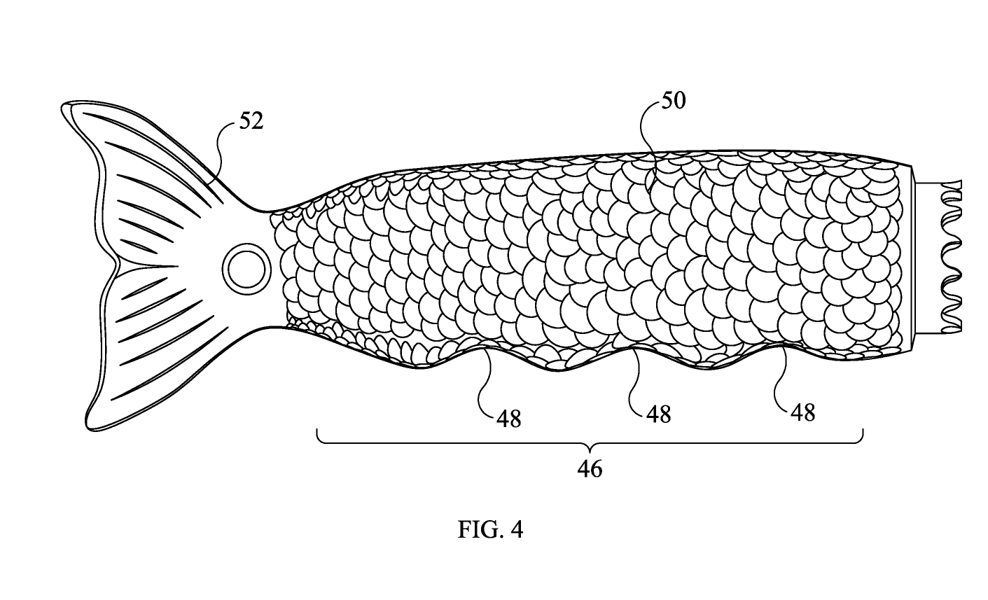

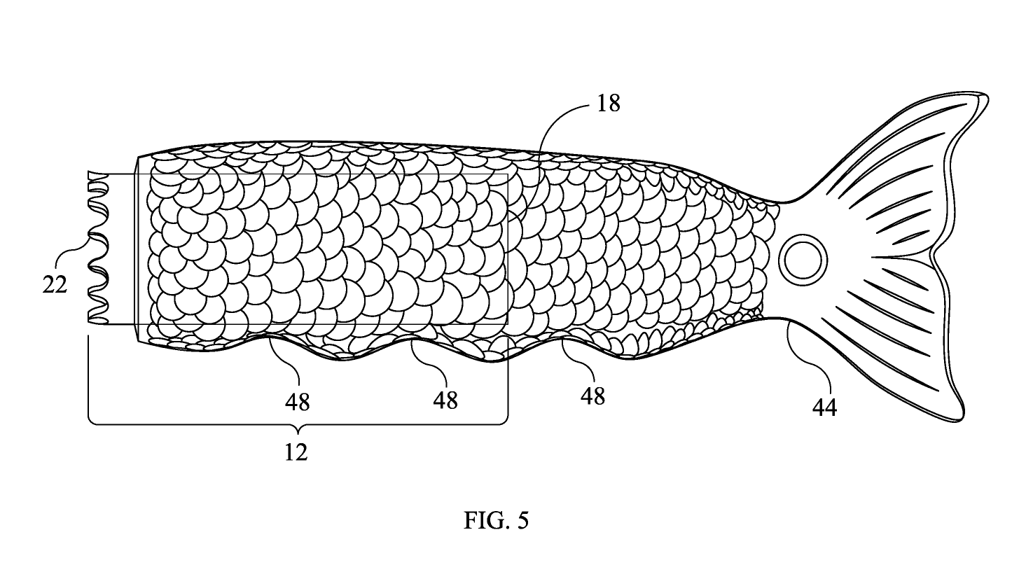

### DETAILED DESCRIPTION

With reference to the drawings wherein like numerals represent like parts throughout the several Figures, a fish securing device is generally designated by the number 10. Fish securing device 10 is especially adapted for securing a portion of a fish or its skin in a manner which permits the user to secure the fish or skin and hold it against a cutting surface at the same time a cutting instrument, such as a knife, is used to carry out any task necessary to clean the fish, such as filleting, skinning, gutting and/or scaling. The fish securing device 10 is adapted for continuous durable usage in a fishing or food preparation environment providing freedom and fluidity of movement for the user and user's hands, ability to readily engage various fish types and thickness during a fish cleaning process, and is easily cleaned and maintained along with the knife and other tools employed in the cleaning of fish, preparing of fish, or fishing in general.

The fish securing device 10 includes a rigid stem 12 of generally elongated cylindrical form with an inner 14 and outer 16 surface. The stem 12 has a central longitudinal axis A. The stem has a proximal end 18 and a terminal end which forms into a sharp securing edge 22 Securing edge 22 extends longitudinally from an axially forward portion of the stem 20 and is integral to the stem 12 with a plurality of repeating segments of teeth 24 at its end. The teeth 24 preferably form a generally serrated saw-like shape or substantially jagged projections, which preferably have tooth forms 28 radially displaced inwardly 30 and outwardly 32 with a gullet 34 between each tooth form 28. The tooth forms preferably forming at least a lower point 36 and higher point 38 with respective points running generally along a common lower line 40 and common higher line 41.

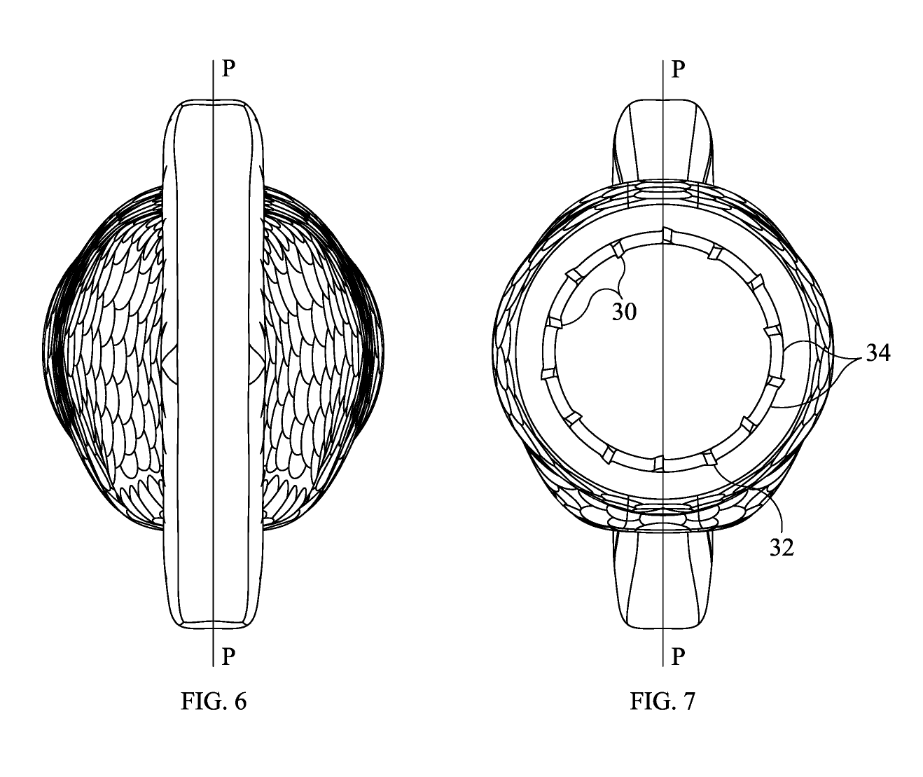

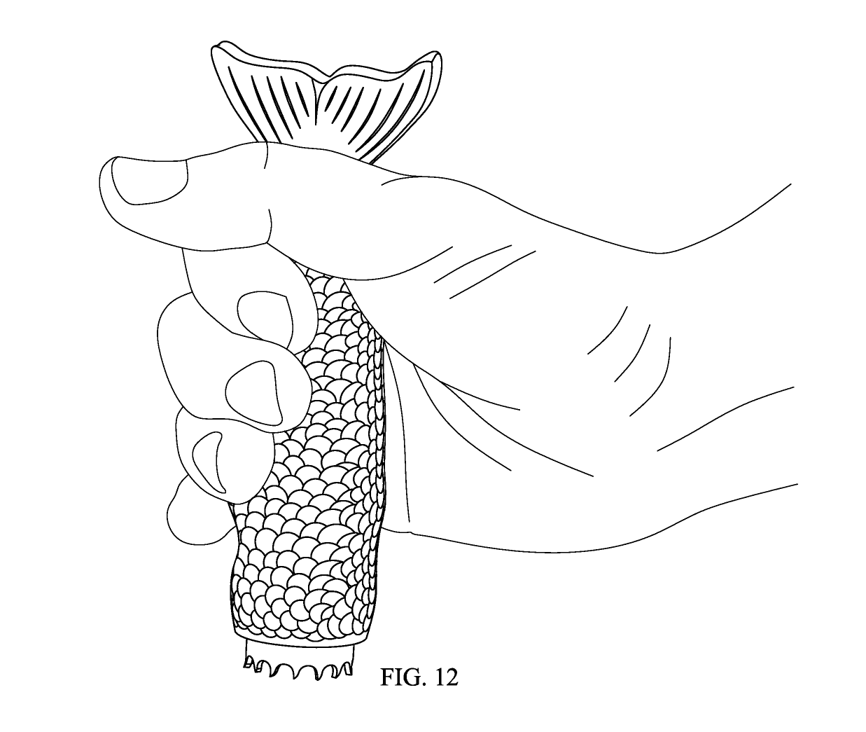

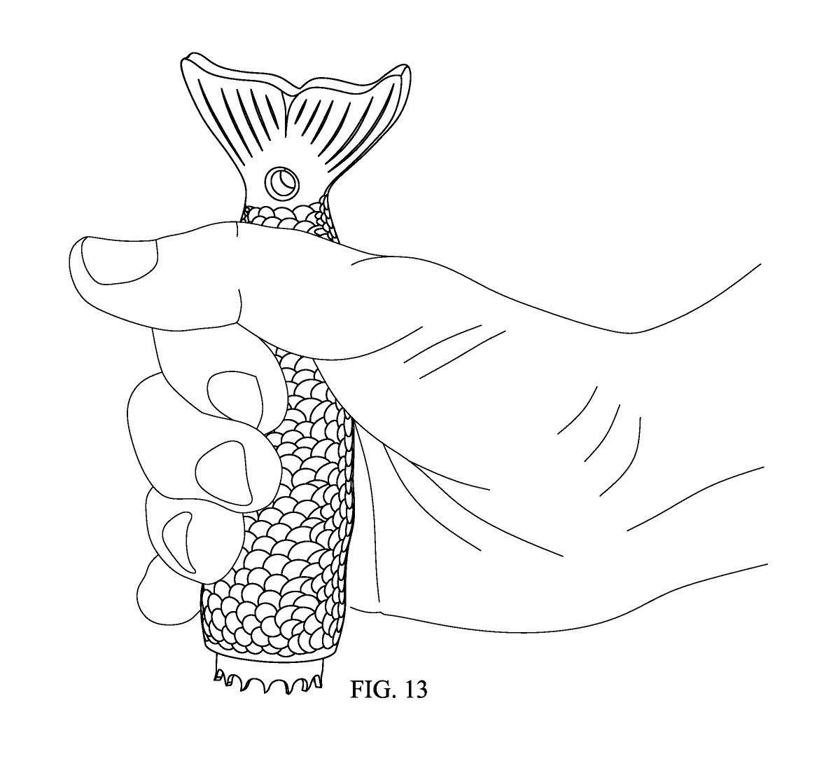

An overmold 42 surrounds a substantial portion of the stem 12 and covers the stem from its proximal end 18 to where the stem 12 extends axially out from the overmold's rounded tapered terminal end 45 so that only the forward portion of the stem 20 is visible. The forward portion 20 then forms a terminal end having a serrated saw-like securing edge 22. The securing edge 22 functions to pierce through the meat or skin of a fish to secure the fish to a cutting surface. The overmold 42 exteriorly forms a fish tail fin 43 at its proximal end 26 and a hand grip portion 46 which extends from the start of the fish tail fin shape 44 to where the forward portion of the stem 20 protrudes from the overmold's rounded tapered terminal end 45. The hand grip portion 46 preferably forms contoured-finger grooves 48 on one side of the overmold 42 to ergonomically fit a user's fingers when closed around the overmold 42. In a preferred form, the overmold 42 has a general exterior profile symmetric about perpendicular planes thru axis A (one plan P is designed in FIGS. 6 & 7) except for one side having finger grooves 48. The overmold 42 functions as a handle which is adapted to be gripped by a user's hand. The proximal end 26 is shaped like a fish tail fin so that a user has the freedom to adjust grip from a closed hand grip using all the finger grooves 48 (one preferred grip is shown in FIG. 13) to a closed hand grip using the start of the fish tail fin shape 44 and any desired finger grooves 48 (another preferred grip is shown in FIG. 12). Other grips are possible. In one embodiment, the overmold 42 is formed from ABS material. Other materials are possible.

A circular opening or through slot 54 is formed in the overmold to facilitate hanging the fish securing device, attaching the fish securing device to a fish line, or otherwise retaining same in a fixed position or to other objects. The slot 54 formed is aligned with axis A in the illustrated embodiment.

A decorative covering 50 completely covers overmold 42. Covering 50, in one embodiment is a thin relatively soft overmold of TPR/TPE material. Other materials are possible. Covering 50 preferably has a main pattern which resembles fish scales or skin. The main pattern is interrupted by a fish-tail pattern 52 beginning at the start of the fish tail shape 44 and ending at the proximal end 26 of the handle. The covering also facilitates gripping of the device.

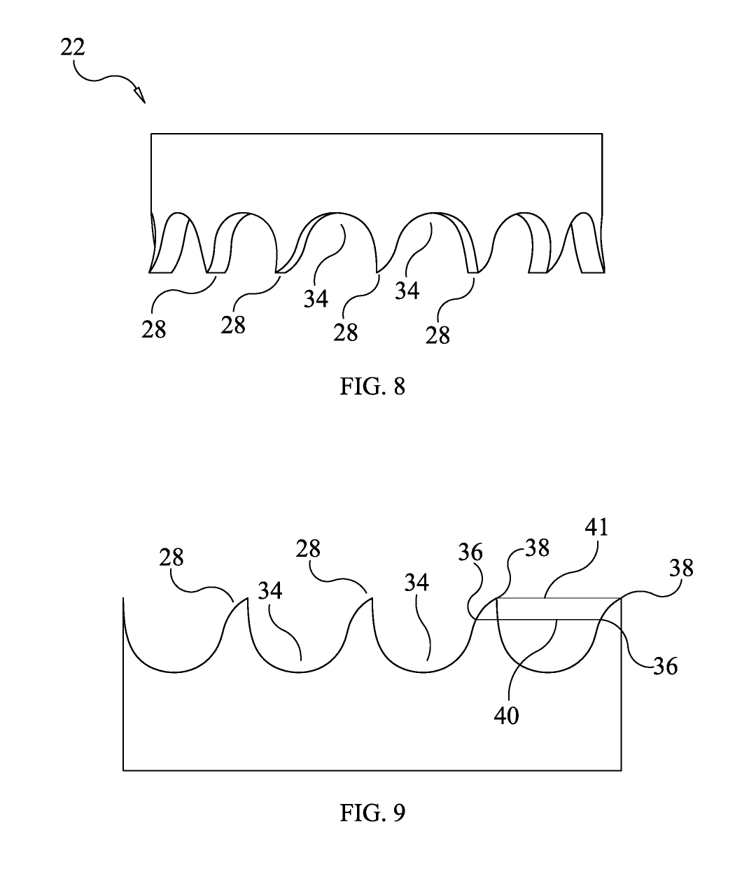

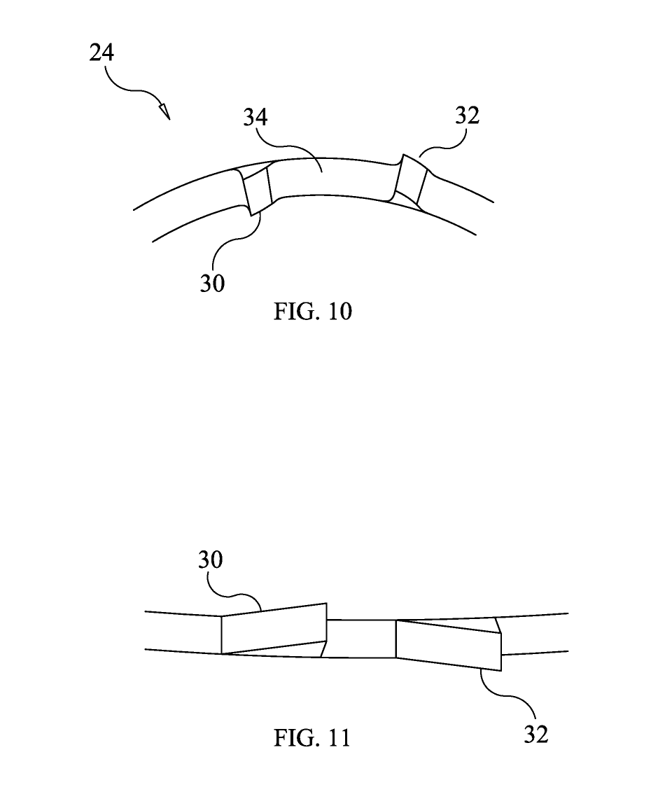

With reference to FIGS. 8,9,10 and 11, the securing edge 22 of the forward portion of the stem 20 is preferably formed by a plurality of repeating segments of teeth 24 having a serrated saw-like shape. In one form, each segment preferably forms at least a first tooth form 28 radially displaced inwardly, 30 and at least a second tooth form 28 radially displaced outwardly, 32 with a gullet 34 between each tooth form. The tooth form preferably forms at least a lower apex-point 36, and at least a higher apex-point 38, with the lower apex-points running generally along lower common apex-line 40, and the higher apex-points running generally along a higher common apex-line 41. Each of the segments of teeth 24 function as a sharp, saw-like surface which engages the flesh or skin of the fish in a multi-point, semi-penetrating, or fully-penetrating manner, depending on the fish type or thickness, to secure a fish against a cutting surface. It is possible for the forward portion of the stem 20 to also penetrate the fish if the fish is thick enough. The saw-like securing edge 22 functions to cut through the flesh and/or skin of a fish to secure it and prevent the fish from moving even when a transverse force is applied by the knife through or across the surface of the fish.

The stem, in one embodiment, is manufactured out of hard plastic or a strip of at least corrosive-inhibiting metal. Other materials are possible. It will be appreciated that the stem 12 and/or securing edge 22 may be dimensioned in various sizes, and the plurality of repeating segments of teeth 24 may be formed otherwise so that the fish securing device 10 is adaptable for a wide variety of fish sizes, thicknesses or cutting surfaces. It will also be appreciated that the tooth form 28 and gullet 34 may have a variety of sizes, apex-points or angles, and the segments of teeth 24 may have various tooth forms alternating in different sequences to allow the most effective securing edge in securing a fish against a cutting surface. It will also be appreciated that the overmold 42 may be dimensioned in various sizes or formed otherwise so that the fish securing device 10 is adaptable for a wide variety of users, hand sizes, finger sizes, or grip styles.

In practice, the fish securing device 10 maybe be effectively and efficiently employed when it is desired to fillet, skin, gut and/or scale a fish during a fish cleaning process. It can be used to hold a fish in place where a user holds the fish securing device in one hand by its handle applying pressure to one end of the fish against a cutting surface with at least the fish securing device's securing edge 22 touching the fish. This method holds a fish firmly to the cutting surface while a user can employ a knife with the other hand to carry out any task(s) associated with cleaning that particular fish such as, scaling, gutting, skinning and/or filleting.

One preferred method of use for filleting a fish with the fish securing device 10, as part of a fish cleaning process, is that while pressing the edge 22 of the fish securing device against the head of a fish, securing the fish head to a cutting surface, a knife can then be used to cut into the fish and run laterally along the spine of the fish, thus removing the fillet from one side of the fish, without significant or any movement of the fish. Other filleting methods are possible when cleaning a fish.

One preferred method of use for skinning a fillet with the fish securing device 10, as part of a fish cleaning process, is by placing the fillet skin side against the cutting surface and while pressing the edge 22 of the fish securing device against one end of the fillet, securing at least a portion of the skin to a cutting surface, a knife can then be used to cut laterally along the inner surface of the skin, thus removing the fillet from the skin without significant or any movement of the fillet. Other skinning methods are possible when cleaning a fish.

One preferred method of use for gutting a fish with the fish securing device 10, as part of a fish cleaning process, is that while pressing the edge 22 of the fish securing device against either end of a fish, securing the fish to a cutting surface, a knife can then be used to cut in the fish and run laterally along the bottom of the fish, thus removing the entrails of the fish without significant or any movement of the fish. Other gutting methods are possible when cleaning a fish.

One preferred method of use for scaling a fish with the fish securing device 10, as part of a fish cleaning process, is that while pressing the edge 22 of the fish securing device against the tail-end of a fish, securing the fish to a cutting surface, the dull edge of a fillet knife can be used to laterally scrape along the exterior surface of the fish, thus removing the scales of the fish without significant or any movement of the fish. Other scaling methods are possible when cleaning a fish.

While preferred embodiments of the foregoing invention have been set forth for purposes of illustration, the foregoing description should not be deemed a limitation of the invention herein. Accordingly, various modification, adaptations and alternatives may occur to one skilled in the art without departing from the essence and the scope of the present invention.

We claim:

1. A fish securing device for cleaning fish, compromising: a stem defining a longitudinal axis; said stem forming an elongated cylindrical shape with an inner surface and an outer surface having an axially forward end defining a securing edge disposed between said surfaces and comprising a plurality of repeating segments of teeth; each segment having at least a first and second tooth form radially displaced inwardly and outwardly of said inner and outer surfaces respectively with a gullet between each tooth form; said tooth form forming at least a lower point and higher point with respective points running generally along its respective lower and higher common line; a handle mounted to said stem as an integral piece; at least a forward portion of said stem with said securing edge extending axially from handle; wherein downward pressure by a user engages at least said securing edge into the fish; and thus secures same during a fish cleaning process.

2. The fish securing device of claim 1 wherein said stem is formed of at least a strip of durable, corrosive-inhibiting material able to pierce through the flesh and skin of a fish.

3. The fish securing device of claim 1 wherein said handle extends from a proximal end to a rounded tapered terminal end from which said forward portion of stem first protrudes.

4. The fish securing device of claim 3 wherein said handle is defined by an overmold generally symmetric to a central plane through said longitudinal axis.

5. The fish securing device of claim 4 wherein said handle has a wide proximal end shaped like a fish tail.

6. The fish securing device of claim 5 wherein said handle has a hand-grip portion generally between its proximal end and rounded tapered terminal end.

7. The fish securing device of claim 6 wherein said hand grip portion has a plurality of finger grooves for ergonomically receiving fingers of a user's hand.

8. The fish securing device of claim 3 wherein said handle is formed of a durable material.

9. The fish securing device of claim 8 wherein said durable material is corrosive resistant.

10. The fish securing device of claim 9 wherein said durable, corrosive resistant material is water buoyant.

11. The fish securing device of claim 1 wherein said handle is formed from an overmold surrounding at least a portion of stem and is generally symmetric to a central plane through said longitudinal axis.

12. The fish securing device of claim 11 wherein said overmold is covered by a covering having a pattern of a multiplicity of adjacent fish scale-like shapes.

13. The fish securing device of claim 12 wherein said covering forms a generally circumferential, longitudinally extending uninterrupted portion.

14. The fish securing device of claim 13 wherein said covering has a fish-tail fin shape at the proximal end of said handle.

15. The fish securing device of claim 11 wherein said overmold is formed substantially of ABS material.

16. The fish securing device of claim 15 wherein said overmold is formed of at least a durable, corrosive resistant, buoyant-in-water material other than ABS material.

17. The fish securing device of claim 12 wherein said covering is formed substantially of TPE/TPR materials.

18. The fish securing device of claim 17 wherein said covering is formed at least of solid, soft touch, non-slip, and abrasion-resistant material other than TPE/TPR.

19. The fish securing device of claim 1 wherein said plurality of repeating segments of teeth have a serrated saw-like shape.

20. The fish securing device of claim 19 wherein said plurality of repeating segments of teeth have substantially jagged projections other than a serrated-saw-like shape.

21. The fish securing device of claim 1 wherein said handle has a through opening intersecting said longitudinal axis.

22. The fish securing device of claim 21 wherein said opening is generally circular and defines a slot axis aligned to said longitudinal axis.

23. The fish securing device of claim 1 wherein downward pressure by user engages at least said securing edge into fish during cleaning process.

24. A fish securing device for cleaning fish compromising: a stem defining a longitudinal axis; a handle mounted to said stem compromising a contoured overmold; said stem and handle being integral, said stem having an inner and outer diameter extending longitudinally with a securing edge at the end of the forward portion of stem not encased by said handle; said securing edge defined by an arrangement of axial protrusions which project at opposing slight angles generally parallel to said longitudinal axis; at least the securing edge being engageable with a fish during cleaning of the fish.

25. The fish securing device of claim 24 wherein said securing edge has a substantially serrated saw-like shape.

26. The fish securing device of claim 24 wherein said protrusions have at least a jagged apex and form a substantially co-planar jagged apex circular array.

27. The fish securing device of claim 24 wherein said overmold surround at least a portion of said stem and is generally symmetric to a central plane through said longitudinal axis.

28. The fish securing device of claim 27 wherein said stem has an elongated, cylindrical shape.

29. The fish securing device of claim 28 wherein at least a portion of said overmold has a hand grip profile with finger grooves.

30. The fish securing device of claim 24 further compromising a covering which covers at least a portion of said overmold and forms the exterior surface area.

31. The fish securing device of claim 24 formed of materials suitable for cleaning fish.
